(19) United States
(12) Patent Application Publication
(10) Pub. No.: US 2009/0082082 A1
(43) Pub. Date: Mar. 26, 2009

(54) GAMING APPARATUS WITH CUSTOMISED FEATURES

(76) Inventors: John Francis Cromwell Carr-Gregg, Gordon (AU); Robert Linley Muir, Artarmon (AU); Martin Stephen Lyons, Beaconsfield (AU)

Correspondence Address: MCANDREWS HELD & MALLOY, LTD, 500 WEST MADISON STREET, SUITE 3400, CHICAGO, IL, 60661, US

(21) Appl. No.: 11/849,741

(22) Filed: Sep. 4, 2007

(30) Foreign Application Priority Data
Sep. 4, 2006 (AU) 2006904826

(51) Int. Cl. A63F 9/24; A63F 13/00

(52) U.S. Cl. 463/20; 463/25; 463/43

(57) ABSTRACT

A gaming machine, a gaming system and associated methods are described in which a player provides a player identifier (PID) and that identifier is used to configure the gaming machine. The identifier may include biometric data. The configuration information may include information on one or more limits on game play and an award may be provided if the limits are not exceeded. In other embodiments, limits on game play may be enforced, for example by terminating game play.

### CROSS REFERENCE TO RELATED APPLICATIONS

This application claims priority to Australian Patent Application No. AU2006904826, having an international filing date of Sep. 4, 2006, entitled “Gaming Apparatus with Customised Features”, which is hereby incorporated by reference herein in its entirety.

### FIELD OF THE INVENTION

The present invention relates to gaming apparatus and methods. More particularly, the present invention relates to the field of gaming machines, gaming systems implementing or including gaming machines, and methods relating to the play of gaming machines.

A particular embodiment of the present invention relates to a customisable gaming apparatus and methods of customising a gaming apparatus. Another particular embodiment of the present invention relates to loyalty or award systems for gaming systems. Another particular embodiment relates to player identification and tracking.

### BACKGROUND OF THE INVENTION

With the increase of gambling at gaming venues has come increased competition between gaming venues to obtain a larger share of the total gambling spend. Gaming venue operators have therefore continuously looked for new variations and types of games in order to attract both new and return customers to their venues.

In response to this need, suppliers of gaming machines and systems have attempted to provide the sought after variety, while still developing games that comply with the relevant regulations in the jurisdiction of the gaming venue operator. Suppliers of gaming devices have been largely successful in providing a large number of different games. As part of, and in addition to any requirements that may be provided for in the relevant regulations, suppliers of gaming machines may implement measures to assist players in the monitoring of their gaming activities and to assist gaming venues to monitor the activities of players.

Players therefore now face a large selection of games at gaming venues. This can make it difficult for a player to find a particular game that is suited to their preferences and that they enjoy playing. A player that can not promptly find a game that they enjoy playing at a gaming venue may leave that venue.

Another response to the increased competition between gaming venue operators has been the introduction of loyalty systems. These loyalty systems may reward return play or play to a certain level at a gaming venue, helping to encourage loyal patronage by players. Gaming venue operators continue to seek ways in which to differentiate their venue so as to make their venue more attractive to players.

### SUMMARY OF THE INVENTION

Certain embodiments of the invention broadly relate to a gaming system including a gaming machine and a configuration device in communication with the gaming machine over a communication channel, the configuration device maintaining in computer memory one or more player identifiers each associated with configuration information, the gaming machine including a player interface to receive a player identifier, wherein the configuration device and the gaming machine communicate over the communication channel to provide the configuration information associated with a player identifier received by the player interface to the gaming machine and wherein the gaming machine configures itself dependent on the configuration information.

The gaming system may include a plurality of gaming machines, each in communication with the configuration device and configurable dependent on configuration information stored in the computer memory.

Certain embodiments of the invention also broadly relate to a gaming machine having a display and a player interface in communication with a computational controller, the gaming machine providing at least one wagering game and further including a communication interface to a communication channel, wherein the player interface is operable to receive a player identifier and the communication interface is operable to communicate the received player identifier onto the communication channel and receive configuration information from the communication channel, wherein the computational controller is operable to receive the configuration information and in response thereto configure at least one aspect of the provision of the at least one wagering game.

The gaming machine may provide a plurality of different wagering games, and the player interface implements a selector that presents a subset of said wagering games and enables a player to select a wagering game to be provided by the gaming machine, wherein the wagering games presented by the selector are at least partly determined dependent on the configuration information.

The configuration information may identify at least one characteristic of games selected from the group including: denomination, volatility, return to player percentage, text display style, text display size, display language, game play speed and bet size.

The gaming machine or gaming system may further include a player monitor that monitors at least one measurable aspect of game play on the gaming machine, and the configuration information includes information identifying a value of at least one of the monitored aspects, wherein the gaming machine implements a predetermined action when there is a predetermined relationship between the value of the monitored aspect and the value identified by the configuration information. The monitored aspect may include at least one aspect selected from the group including: turnover, time played, rate of play and/or rate of expenditure, and wager size per game play. The predetermined relationship may include the monitored aspect reaching a predefined percentage of the value identified by the configuration information and/or the monitored aspect reaching the value identified by the configuration information. The predetermined action may include at least one of the display of a notification on the display and the implementation of a penalty to the player of the gaming machine. The penalty may be a reduction or forfeit of an award that the player would otherwise win or be eligible to win.

The gaming machine may be operable to receive at the communication interface historical information on at least one said monitored aspect, combine the historical information with current information on the monitored aspect and compare the resulting combined value with the value identified by the configuration information. The gaming machine may communicate the combined monitored information to a remote device using the communication interface at the end of a gaming session.

The gaming machine may provide an award if a limit on a monitored aspect defined by the configuration information is not exceeded. In one embodiment the configuration information defines a plurality of limits and gaming machine provides one of a plurality awards depending on which limits have not been exceeded.

The communication channel may include a wide area network and the plurality of gaming machines include at least two gaming machines that are at remote physical locations from each other.

Certain embodiments of the invention also broadly relate to a method for use with a gaming machine having a display and a user interface in communication with a computational controller, the gaming machine including a communications interface for communicating with a computational device separate from the gaming machine, the method including:

receiving at the user interface an identifier of a player;

using the communications interface communicating the identifier onto a communications channel;

receiving configuration information at the computational controller; and

configuring at least one aspect of the computational controller in response to receipt of the configuration information.

The method may include monitoring at least one aspect of game play on the gaming machine and the configuration information includes information identifying a value for each monitored aspect, wherein the configured aspect of the computational controller includes generating a notification that the value has been exceeded. The method may further include combining a monitored aspect of game play on the gaming machine with previously recorded values and generating the notification when the sum exceeds the value. The monitored aspect may include at least one aspect selected from the group including: turnover, time played, rate of play and/or rate of expenditure, and wager size per game play.

The configuration information may include information identifying a plurality of games available to be played at the gaming apparatus, the plurality of games representing a subset of all the games available to be played at the gaming machine and wherein the method further includes presenting the plurality of games on the display, receiving from the player interface a selection of one of the games and initiating play of the selected game.

The configuration information may uniquely identify particular games or may identify one or more characteristics of games, in which case the method may further include comparing game characteristics of the games available to be played at the gaming machine with the one or more characteristics to identify the subset of games. Where the configuration information uniquely identifies particular games, the method may further include receiving the identifier at another computational device and using the other computational device to compare game characteristics of the games available to be played at the gaming apparatus with the one or more characteristics to identify the subset of games.

The configuration information may identify one or more games having a particular denomination, volatility and/or return to player percentage or range of denominations, volatilities or return to player percentages.

The configuration information may identify a display style, size and/or language to be used for textual information displayed on the display and the method includes displaying at least certain textual information in the identified display style, size or language.

The configuration information may identify one or more games having a particular speed of play or range of speeds of play.

The configuration information may identify a bet size or range of bet sizes and the method includes setting a limitation on the bets playable on the gaming machine dependent on the identified bet size or range of bet sizes.

The communications interface may be a modem and the method includes communicating the identifier onto a wide area network and receiving the configuration information from the same wide area network.

Certain embodiments of the invention also broadly relate to a gaming system including at least one gaming machine operable to allow a player to identify themselves to the gaming system, and including a monitor for monitoring an aspect of game play by an identified player, wherein the gaming system stores at least one threshold for the monitored aspect and provides an award to the player if the threshold is not exceeded.

The monitored aspect of game play may be at least one aspect selected from the group including: turnover, time played, rate of play and/or rate of expenditure, and wager size.

The monitor may monitor a plurality of aspects and either provides an award if a threshold relating to any one of the aspects is not exceeded or provides an award only if every threshold relating to all of the monitored aspects is not exceeded.

In one embodiment, the award may be an award of credits on the gaming machine. In another embodiment the award may be monetary value only able to be collected following termination of a current gaming session on the gaming machine. In another embodiment the award may only be redeemable for goods or services and not credits.

The gaming system may provide another award if the threshold is exceeded, but a second threshold is not exceeded, the other award being lesser in value than the award. Further reduced awards may be provided for not exceeding a third and subsequent thresholds.

The value of the award may be determined dependent on a measure of the magnitude of gaming activity by the player, for example total spend.

When a threshold is first exceeded, the gaming system may provide a notification of this event and provides an option to cash out/quit now and still receive the award, or continue play without receiving the award.

Certain embodiments of the invention also broadly reside in a gaming machine including a player interface that includes a game play activator, wherein the game play activator includes a fingerprint scanner that scans a fingerprint of a player when that player operates the game play activator by placing his or her finger on the game play activator for a duration sufficient to obtain the scan.

The game play activator may include a contoured surface that tends to locate a finger of player onto the fingerprint scanner. The game play activator may include at least one indicator, the indicator indicating to the player the status of the fingerprint scanner. The status of the fingerprint scanner may include a first status in which a fingerprint scan is required and is yet to be completed and a second status in which a fingerprint scan has been obtained.

Certain embodiments of the invention also broadly reside in a gaming system including a plurality of gaming machines that implement a ticket-in-ticket-out system for recording credit of a player, wherein the tickets include a player identifier that is associated in a database system with biometric information and wherein the gaming machines each include a biometric data reader and require the provision of biometric data before allowing redemption or spending of funds from a ticket, wherein said redemption or spending is refused if the biometric data does not match the biometric information associated with the player identifier.

The gaming system may store a record of unredeemed or spent funds on tickets.

Certain embodiments of the invention also broadly reside in storage containing instructions for causing an electronic processing system to perform any of the methods described in the immediately preceding paragraphs. The invention may also broadly reside in such instructions for an electronic processing system.

Further aspects of the present invention will become apparent from the following description, given by way of example and with reference to the accompanying drawings. Aspects of the invention are also described in the appended claims.

### BRIEF DESCRIPTION OF THE DRAWINGS

The present invention will now be described, by way of example only, with reference to the accompanying drawings, in which:

FIG. 1: shows diagrammatically, a view of a gaming machine suitable for implementing certain embodiments of the present invention.

FIG. 2: shows a block diagram of gaming apparatus suitable for implementing certain embodiments of the present invention.

FIG. 3: shows a block diagram of components of the memory of the gaming apparatus represented in FIG. 2.

FIG. 4: shows diagrammatically, a network gaming system suitable for implementing certain embodiments of the present invention.

FIG. 5: shows a flow diagram of a process performed by the network gaming system of FIG. 4 according to an embodiment of the invention.

FIG. 6: shows a flow diagram of the configuration process that may be completed in accordance with the process shown in FIG. 5.

FIG. 7: shows a diagram of the status dependent actions that may be completed in accordance with the process shown in FIG. 5.

FIG. 8: shows diagrammatically a plan view of a game play activator button according to an embodiment of the invention.

FIG. 9: shows a front view of a cash redemption terminal according to an embodiment of the invention.

FIG. 10: shows a block diagram of the components of the cash redemption terminal shown in FIG. 9.

### DETAILED DESCRIPTION

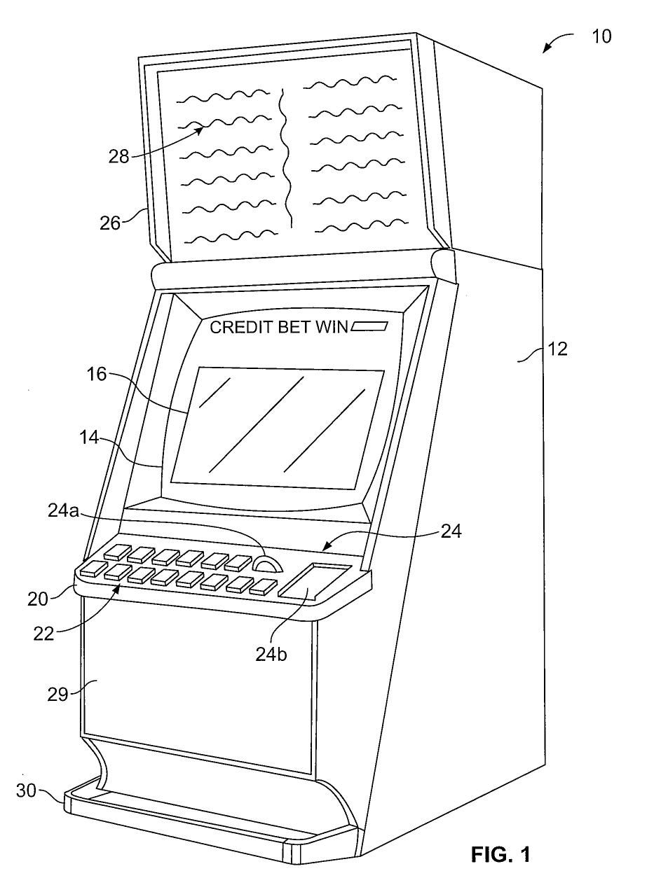

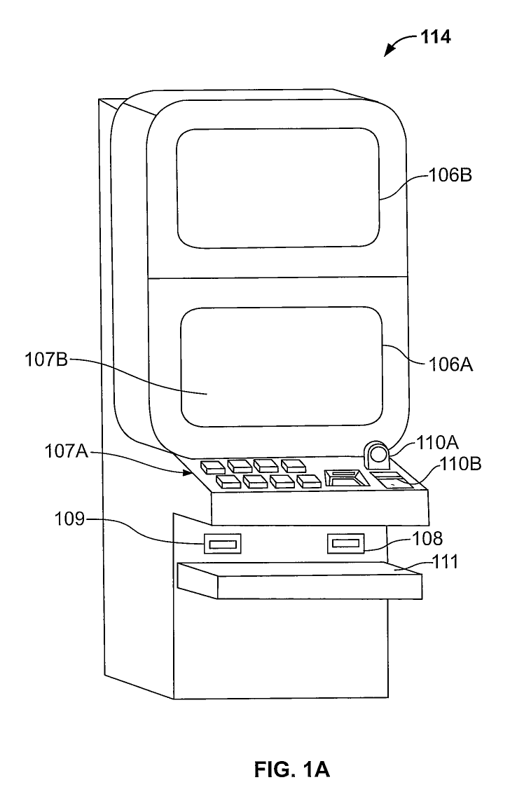

In FIG. 1 of the accompanying drawings, one example of a gaming machine suitable for implementing embodiments of the present invention when communicably connected to a suitable communication channel, is generally referenced by arrow 10.

The gaming machine 10 includes a console 12 having a display 14 on which is displayed representations of a game 16, that can be played by a player. A mid-trim 20 of the gaming machine 10 houses a bank of buttons 22 for enabling a player to play the game 16. The mid-trim 20 also houses a credit input mechanism 24 including a coin input chute 24A and a bill collector 24B. A top box 26 may carry artwork 28, including for example, pay tables and details of bonus awards and other information or images relating to the game. Further artwork and/or information may be provided on the front panel 29 of the console 12. A coin tray 30 is mounted beneath the console 12 for cash payouts from the gaming machine 10.

The display 14 shown in FIG. 1 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or a different type of display.

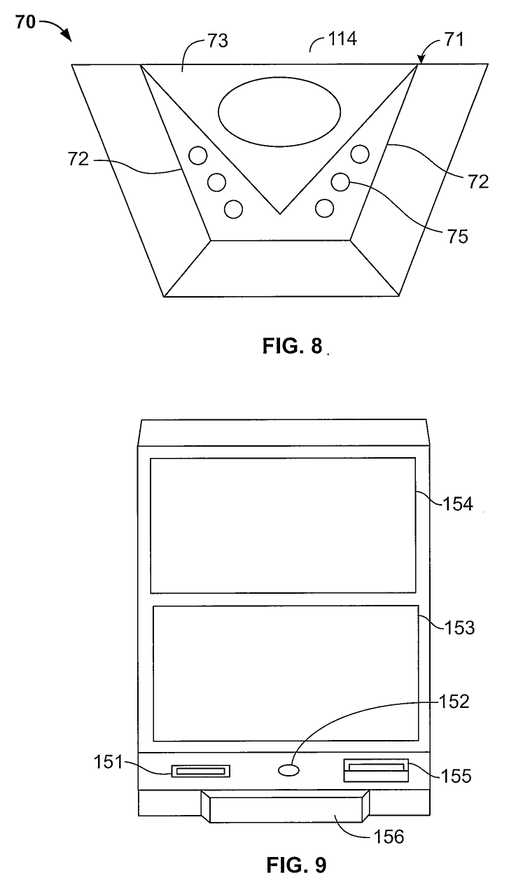

FIG. 1A shows an alternative gaming machine 114 for use with certain embodiments of the present invention. The gaming machine 114 includes a primary display 106A and a secondary display 106B, a touch screen 107B and a player input 107A, which includes a play activator button 70 that is explained in more detail later herein. The gaming machine also includes a card/ticket reader 108, a printer 109, a coin input 110A, a bill acceptor 110B and a coin output 111. If the gaming machine 114 implemented cashless play, for example using ticket-in-ticket-out (TITO) play, then the coin input 110A, bill acceptor 110B and coin output 111 may be omitted. The gaming machine 114 further includes a fingerprint scanner 114, which provided on the button 70 (see FIG. 8).

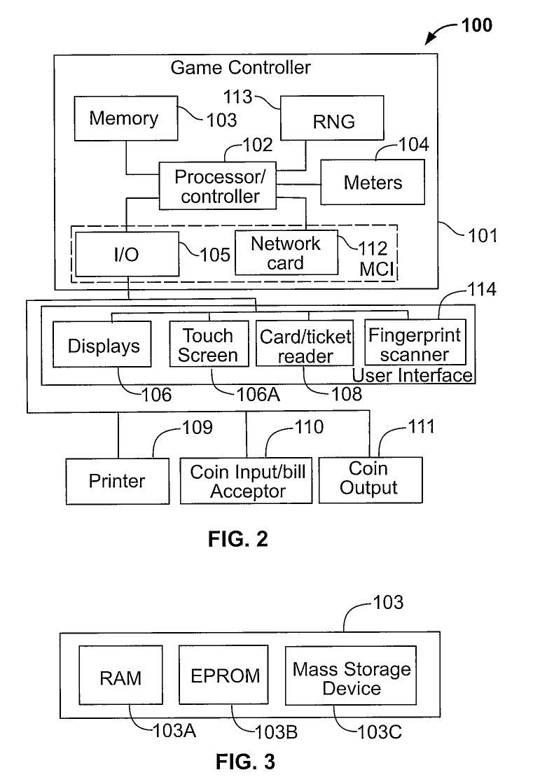

FIG. 2 shows a block diagram of a gaming apparatus, generally referenced by arrow 100, suitable for implementing certain embodiments of the present invention. The gaming machine 100 may operate as a networked gaming machine, communicating with other network devices, such as one or more servers or other gaming machines. The gaming machine 100 may also have distributed hardware and software components that communicate with each other directly or through a network. Accordingly, different reference numerals have been used in FIG. 2 from FIG. 1 for components that may be equivalent.

The gaming machine 100 includes a game controller 101, which in the illustrated example includes a computational device 102, which may be a microprocessor, microcontroller, programmable logic device, or other suitable device. Instructions and data to control operation of the computational device 102 are stored in a memory 103, which is in data communication with, or forms a part of the computational device 102. Typically, the gaming machine 100 will include both volatile and non-volatile memory and more than one of each type of memory, with such memories being collectively represented by the memory 103. The instructions to cause the game controller 101 to implement the present invention will be stored in the memory 103. In one particular embodiment, the computational device 102 is a programmed EPROM.

The gaming apparatus may include hardware meters 104 for the purposes of regulatory compliance and also include an input/output (I/O) interface 105 for communicating with the peripheral devices of the gaming machine 100. The input/output interface 105 and/or the peripheral devices may be intelligent devices with their own memory for instructions and data.

In the example shown in FIG. 2, the peripheral devices that communicate with the controller are one or more displays 106, user interfaces 107, a card and/or ticket reader 108, a printer 109, a bill acceptor and/or coin input mechanism 110 and a coin output mechanism 111. One or more of the displays 106 may include a touch screen 106A, forming part of the user interface 107. The gaming device may further include a biometric data reader, for example a fingerprint reader 114, which is used in certain embodiments described herein. Additional devices may be included as part of the gaming machine 100, or devices omitted as used in the specific implementation.

In addition, the gaming machine 100 includes a communications interface, for example a network card 112. The network card may for example send status information, accounting information or other information to a central controller, server or database and receive data or commands from a the central controller, server or database. The network card 112 and the I/O interface 105 may be combined into a single machine communications interface (MCI). The MCI may allow some of the peripheral devices to communicate with a network without those communications passing through or being processed by the computational device 102.

The game controller 101 may also include a random number generator 113, which generates a series of random numbers that determine the outcome of a series of random game events played as part of a game on the gaming machine 100. The computational device 102 may include two or more controllers or processors, which may be local or remote from each other and the displays 106.

FIG. 3 shows an exemplary block diagram of the main components of the memory 103. The RAM 103A typically temporarily holds program files for execution by the computational controller 102 and related data. The EPROM 103B may hold be a boot ROM device and/or may contain some system or game related code. The mass storage device 103C is typically used to store game programs, the integrity of which may be verified and/or authenticated by the computational controller 102 using protected code from the EPROM 103B or elsewhere.

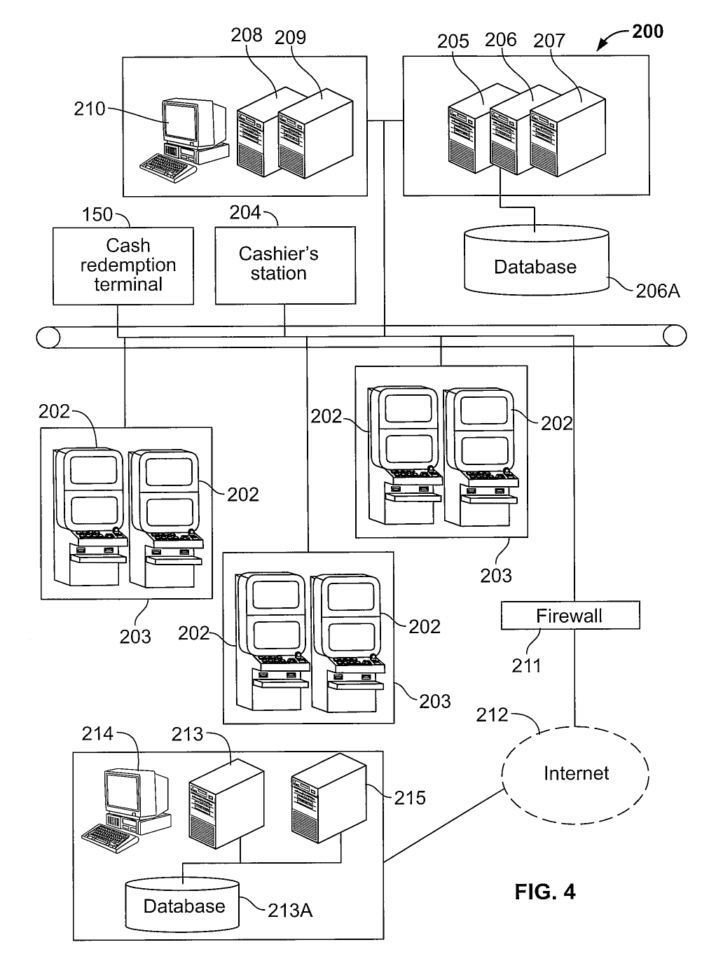

FIG. 4 shows a gaming system 200. The gaming system 200 includes a network 201, which for example may be an Ethernet network. Gaming devices 202, shown arranged in three banks 203 of two gaming devices 202 in FIG. 4, are connected to the network 201. The gaming devices 202 may be gaming machines 10, as shown in FIG. 1 or form part or all of another gaming machine 100. Single gaming devices 202 and banks 203 containing three or more gaming devices 202 may also be connected to the network 201.

Servers may also be connected to the network 201. For example, a game server 205 if provided may generate game outcomes for games played on the gaming devices 202, a database management server 206 may manage the storage of player accounts, player profiles and associated data for downloading or access by the gaming devices 202 in a database 206A, and a jackpot server 207 may control one or more jackpots associated with the gaming devices 202. The servers may be implemented on separate physical devices or as separate server processes on the same physical device.

Further servers may be provided to assist in the administration of the gaming system 200, including for example a gaming floor management server 208, and a licensing server 209 to monitor the use of licenses to particular games. An administrator terminal 210 is provided to allow an administrator to run the network 201 and the devices connected to the network.

The gaming system 200 may communicate with other gaming systems, other local networks, for example a corporate network and/or a wide area network such as the Internet 212 through a firewall 211 and suitable communication servers (not shown). A configuration server 213 and player monitoring device 215 with associated computer memory in the form of a database 213A may be connected to the internet 212. Alternatively, the configuration server 213 and/or player monitoring device 215 may be directly connected to the network 201 or a local connection device for interfacing to the network 201 may be provided in addition to the configuration server 213 and player monitoring device 215. The configuration server 213 and player monitoring device 215 may be implemented in a single physical device, or as separate devices at the same or different locations and each device may optionally have its own memory as opposed to sharing the single database 213A or have a dedicated memory space in the database 213.

The gaming system 200 further includes one or more cashier's stations 204, at which players may redeem their tickets if the gaming devices 202 print tickets when a player cashes out. Some functions of the cashier's station 204 may be provided at an automated cash redemption terminal 150, which is described in more detail herein below.

Configuration Process

FIG. 5 shows a flow diagram of a process performed in accordance with an embodiment of the present invention. The process will be described as it would be implemented by the gaming system 200 including gaming machine 100 implemented at least in part by gaming devices 202, although those skilled in the relevant arts will appreciate that the functions attributed to particular devices in the gaming system 200 may be performed by other devices. For clarity of explanation, the remainder of the description refers to a gaming machine 10 to mean any one of the gaming machine 10, gaming machine 114, gaming machine 100 or gaming device 202 described herein previously.

At step 50, a gaming machine 10 is in “attract mode”, awaiting initiation of game play by a player. When it is detected that a player wishes to play a game on the gaming machine 10 (step 51), the gaming machine 10 determines whether the player has provided a player identifier (step 52). If a player identifier has not been provided and if anonymous play is permitted, then ordinary game play is commenced (step 53), the player being anonymous to the gaming system 200. The gaming machine 10 may display on its display 106 a prompt asking a player to input a player identifier.

The player identifier may be a code or other information, for example biometric information such as a fingerprint read by the fingerprint reader 114. The player identifier may be stored on a card, for example a magnetic stripe card or a smart card or on a ticket and read by the card/ticket reader 108, or may be entered by a player using the user interface 107 of the gaming machine 10.

Following receipt of the player identifier, the gaming machine 10 uses its network card 112 to communicate the player identifier PI onto the network 201 (step 54). The gaming machine 10 sends a gaming machine identifier GMID with the player identifier. This information is received by another device, which may be local to or remote from the gaming machine 10 and network 201. In one embodiment, the information is sent using the TCP/IP protocol to a predetermined address in the internet 212, the address being the IP address of the configuration server 213, or one of a plurality of configuration servers 213 that cooperate to store and find information relating to the player identifier when it is received at one of the configurations servers 213.

The configuration server 213 receives the player identifier (step 70), looks up its database 213A, reads any configuration information CI associated with that player identifier and communicates the configuration information back to the gaming system 200 (step 71). The configuration information is preferably sent back to the network using the same communication channel and protocol as was used to send the identifier to the configuration server 213, although in some embodiments separate communication channels may be used, which may utilise different protocols.

The configuration information is returned with the gaming machine identifier, enabling the configuration information to be addressed to the gaming machine 10 by the gaming system 200. Alternatively, if the gaming system maintains records of what gaming machine 10 each identified player is playing within the gaming system 200, for example using the gaming floor management server 208, the configuration information may be addressed to the gaming floor management server 208, which would enable the gaming system 200 to look up what gaming machine 10 the player is currently stationed at and address the configuration information to that gaming machine 10. The configuration information could then be cached locally for use by the gaming system 200 should the player play another gaming machine 10, in which case the configuration information may be more readily and quickly available. The gaming machine 10 then receives the configuration information from the network 201 through the network card 112 (step 55).

Following receipt of the configuration information, the gaming machine 10 is then configured in accordance with the configuration information (step 56). The configuration information may specify particular games or specify particular characteristics of games such as denomination, volatility, return to player percentage, or game play speed. The configuration information may also specify particular modes of presentation, including particular display styles, display sizes and/or languages. The configuration information may also specify other characteristics associated with game play such as preferred bet sizes for games. The configuration information may also specify a player history, for example for the purposes of monitoring any longer term thresholds (see later herein) for game play that may span a plurality of gaming sessions.

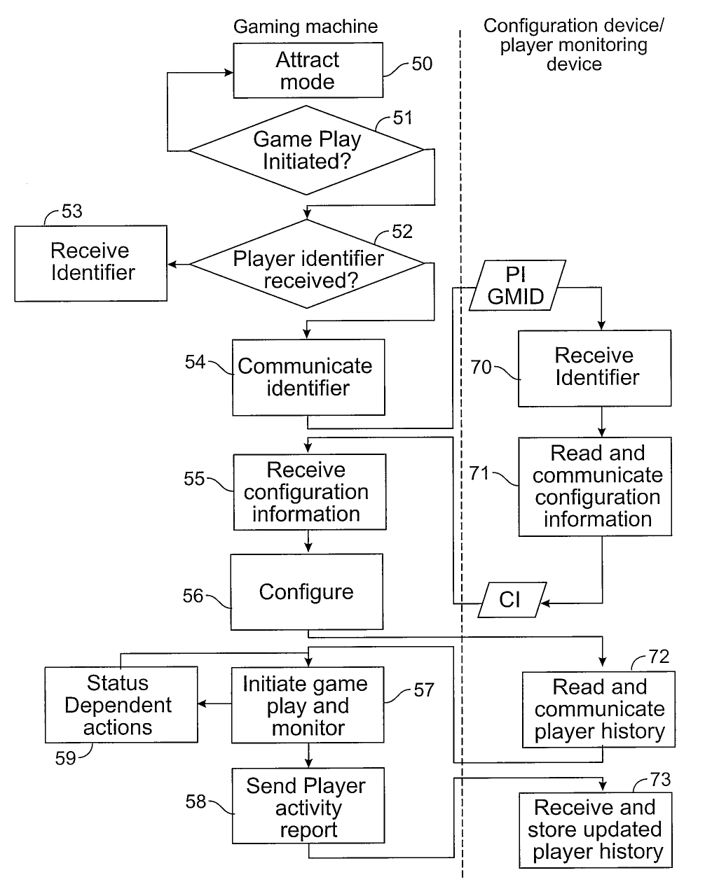

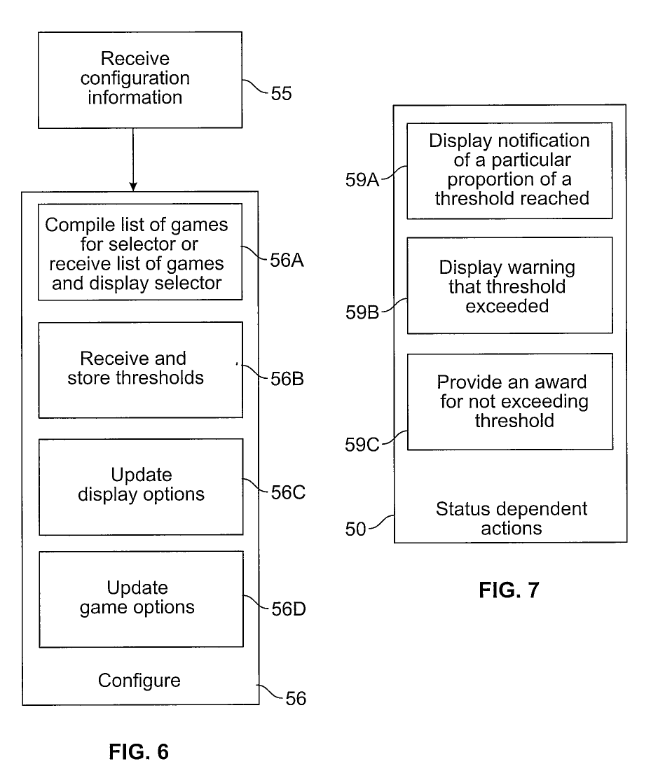

FIG. 6 shows steps 55 and 56 from the flow chart of FIG. 5, with various options for step 56 shown. For gaming machines 10 that are able to play a plurality of games, the configuration information may be used to prepare a list of games for selection by the player (step 56A). A list of games preferred by a player may be stored at the configuration server 213 and communicated to the gaming system 200. The gaming system 200, more specifically and by way of example the gaming floor management server 208, may then determine which games in that list, if any, can be played at the gaming machine 10 and present those games to the player for selection. A suitable selector implemented by the gaming device 202 would be to display icons of each game on the display 106 and monitor the touch screen 106A for the selection of a game, although many alternative selectors may be used.

Alternatively, a list of preferred game characteristics may be stored at the configuration server 213. These game characteristics may specify, for example, preferred denominations, volatilities, return to player percentages, and/or game play speeds. These characteristics are then compared with the characteristics of games available to be played at the gaming machine 10 and those games, or a selection of those games that match the criteria may be presented for selection.

The selection of games that are presented to the player may also be made in part by listed games stored at the configuration server 213, and in part by games that match preferred game characteristics stored at the configuration server 213 and/or in part by games selected without reference to a preferred game list or preferred characteristics. The preferred game list and/or preferred characteristics may be able to be automatically updated depending on player history information. For example, if a player spends a significant amount of time playing a particular game, then that game may be entered in the preferred game list, or given a higher importance rating if it is already in the list. Also, the characteristics of the game may be used to modify the preferred game characteristics stored at the configuration server 113. Where the characteristics are modified, an averaging technique may be used to smooth out large variations in game recommendations.

The preferred game list and/or preferred characteristics may be dynamic and updated over time based on player history information relating to the choices that the players have made in the past. When game characteristics are used, some characteristics may be given a higher priority or weighting over others. For example, denomination may have a higher priority or weighting over game speed.

The provision of multiple games by the gaming machine 10 may be achieved in a number of ways. One option is for a plurality of game programs to be stored in memory at the gaming machine 10. Another option is for the game programs to be stored in the database 206A and downloaded to the gaming machine 10 as required. Another option is for games from the database 206A to be received by and executed by the game server 205, with game outcomes and/or information for display on the display 106 being communicated to the gaming machine 10.

The configuration information may also include thresholds for game play activity. For example, a player may indicate that he:

does not wish to spend over $200 in any single day or gaming session;

does not wish to make a single wager in excess of $2.00;

does not wish to spend more than three hours playing a single gaming session;

does not wish to spend more than $60 in an hour;

does not wish to play for than three hours in any single day; and/or does not wish to play more than two hours in any single gaming session.

These thresholds are stored for use during game play (step 56B). As explained in more detail below, these thresholds may be compared against game activity and action taken if any of the thresholds are exceeded or approached.

The configuration information may further include display options, with the gaming machine 10 implementing different game screen and information screen displays depending on the configuration information (step 56C). For example, a player with poor eyesight may have this indicated in the configuration information. If possible, the gaming machine 10 then displays at least some text in bold or in a larger font to make it easier to read or takes other measures to facilitate communication of information to the player. This configuration information may also affect a list of games presented to a player, with the list focussing on those games that support players with poor eyesight, either in their normal state or by having two or more display options.

The configuration information may further include game options and the game provided with the options specified by the configuration information (step 56D). For example, some bet options may be rendered inactive if they would result in the placing of a wager above a maximum wager value or outside a range of wager values specified in the configuration information. The game controller 101 may be programmed to receive the configuration information and prevent acceptance of certain bets, or the user interface 107 may be connected to a machine communications interface and be controlled remotely, for example by the gaming floor management server 208, which may receive the configuration information that relates to the operable wagers. The control may result in certain buttons being disabled that result in a wager over a certain size or prevent acceptance of certain wager combinations. For example in a spinning reel game, the placing of a maximum bet constituting a combination of the purchase of a high number of pay lines with a high wager per pay line may be prevented.

Following the configuration step (step 56), the gaming machine 10 allows game play and monitors at least one aspect of the game play (step 57). If the game controller 101 is not functional to track game play, the tracking function may be performed by a player tracking module (not shown) of a type well-known in the art.

The measure of game play may be added to historical information from other gaming sessions, the historical information being received by the gaming machine 10 from the player monitoring device 215, which also receives the player identifier from the gaming machine 10. At the end of each gaming session on a gaming machine 10 a player activity report is sent by the gaming machine to the floor management server 208 and subsequently sent to the player monitoring device 215. The player monitoring device 215 receives the report (step 73) and updates the records in the database 213A. Alternatively the report may be sent directly to the player monitoring device 215, particularly if the player monitoring device 215 is in direct communication with the network 201.

The monitoring may be cumulative over a period of time, for example over a day, two days, a week or a month and multiple monitors may be implemented, for example a daily monitor and a weekly monitor and a monitor for total spend, total wins and average rate of play for each time period. The player activity data could be accessed by multiple gaming systems 200 through the internet 212.

In certain embodiments, game play monitoring is performed by the gaming machine 10. In other embodiments, the monitoring may be performed by another device, for example the gaming floor management server 208, which can then receive the thresholds and cause notifications or other action to be made when the thresholds are exceeded. The gaming machine 10, if it executes the game, may send game play information to this other device.

The gaming machine 10 monitors game play by the player and compares the game play to the thresholds specified in the configuration information. Using the example of configuration information that specifies total spending limit of $200 in a day or single gaming session, the gaming device 202 may display on the display 106 notification messages when $100 and $150 have been spent (representing half and three quarters of the threshold) and a warning message when $200 has been spent.

The configuration information may be entered specifically, and/or determined based on other information supplied by the player, for example player preferences, psychological, demographic and/or language profile. The configuration information may be able to be entered by an administrator using a terminal 214 connected to the configuration server 213. The terminal 214 may also be used to administer the player monitoring functions.

A loyalty or reward scheme may be implemented using the thresholds in the configuration information. For example, if a player plays a gaming session without exceeding any of the thresholds, they may be awarded an award at the end of the gaming session. This award may be in form of credits, a monetary award that is only available after completion of the gaming session, for example when cashing out or at a cashier's station, and/or may be credits towards other goods or services, for example beverages or food at a restaurant at the gaming venue.

The awards may be based on continuous play without exceeding any thresholds and/or for repeat play without exceeding any thresholds. An award may still be provided if one or more of the thresholds is exceeded, but the award may be reduced because of the exceeding of the threshold. The player may be notified of the reasons why the award was reduced and any notification messages relating to the approaching or exceeding of the threshold may notify the player that the award will be reduced if the threshold is exceeded. Alternatively only a single award may be available, which is forfeited by exceeding a threshold or limit set by the configuration information.

While in certain embodiments the configuration information specifies the thresholds applicable to each particular player, in an alternative embodiment players may be grouped into categories and deemed to have common configuration information.

When a threshold is exceeded, the warning message may specify the option to cash out now and still receive the award, or continue playing and forfeit or reduce the award. If the player continues playing, and the particular implementation allows for reduced awards despite the continued play periodic notifications may indicate that the award is being further reduced and giving the option to cash out now to avoid this further reduction.

The award may be a fixed value that becomes available after a player has spent a minimum amount. This minimum amount is preferably able to be achieved over multiple gaming sessions at different gaming machines 10, although it could also be a minimum amount for the current gaming session. Alternatively, the value of the award may be based on the spend by the player, with the award value increasing the more the player spends. The amount of the award, the rate at which the award increases with play activity and/or eligibility criteria may be configurable parameters.

Biometric Data Capture

In one embodiment, a player may identify themselves by placing a finger on the fingerprint scanner 114. Suitable scanners are currently available and used, for example, on some portable computers as an added or alternative security measure to passwords and other identifiers. The capture of biometric data may be used as the sole player identifier, or may be used in combination with another identifier such as a player card, for example to ensure that the player is using his or her own player card and not another player's card.

While the fingerprint scanner may be placed anywhere on the gaming machine, in one embodiment it is incorporated into a ‘play’ or ‘spin’ button 70. The gaming machine 10 would be configured so that the buttons that select the amount to be wagered do not automatically commence a game play, with the player instead required to push the ‘play’ button 70. FIG. 8 shows a plan view of such a ‘play’ button 70.

The button 70 is mechanical push-button that is at least about three finger-widths wide. The button 70 includes a contoured top surface 71 that includes guides 72 shaped and positioned to assist a player to place their finger on the fingerprint scanner 114. The guides 72 include inclined surfaces that incline downwards towards the fingerprint scanner 72, so that by placing their finger on the button 70 the player can follow the inclined surfaces downwards to a level surface 73 in which the fingerprint scanner 114 is located.

The button 70 may also include an indicator. In the embodiment shown in FIG. 8 the indicator is in the form of six pairs of light emitting diodes 75 (one pair only indicated in FIG. 8), with each pair sharing a common aperture through which light is transmitted to be visible to a player of the gaming machine 10. As explained in more detail below, the indicator may be used to indicate the status of the gaming machine 10.

If the gaming machine has a ‘play’ actuator in the form of a lever, then the fingerprint scanner 114 may be provided in the lever.

Use of the Biometric Data

As explained herein above, a gaming machine may be reconfigured after a player has been identified. This reconfiguration may occur after a player has been identified using the fingerprint scanner 114.

The use of fingerprints or other biometric data to identify a player has the advantage that the player can be uniquely identified. If a player is required to enter a fingerprint to play a gaming machine 10, then it becomes more difficult for a player to play using another identity. Further, anonymous play by a previously identified player, who may be identified as a problem gambler or potential problem gambler, may be prevented, or at least made more difficult.

The gaming machine 10 may be configured to prevent play until such time as the player has been identified. In this embodiment, only players who have previously registered themselves may be permitted to play the gaming machine 10. Players may register themselves at a register station, which may include an administrator terminal 210, 214 connected to a fingerprint scanner. The player may register a finger or all of their fingers for example using a full double hand scanner, with this information being stored in the database 213A, along with a player profile and optionally a player account.

The LEDs 75 may include a plurality of different coloured LEDs, for example a plurality of pairs of green and yellow LEDs. Before the player's fingerprint has been read and identified, the green LEDs are not illuminated and the yellow LEDs flash to indicate that the player needs to allow their fingerprint to be read by the fingerprint reader 114. After the player has been identified and the relevant player configuration information downloaded to the gaming machine 10 if the download of configuration information is dependent on the fingerprint scan, then the green LEDs may be illuminated constantly and the yellow LEDs not illuminated.

As described previously, after the player has been identified, the player's profile is downloaded to the gaming machine 10. The player's profile may indicate that the player is not to be allowed to gamble, in which case the gaming machine 10 may immediately cash out the player. This may occur for example, because the player is an identified problem gambler, or because the player profile indicates that the player has exceeded their maximum duration of play in a day or single gaming session.

The gaming machine 10 may require confirmation of the identity of the player during the course of a gaming session. This may be used to help prevent one player identifying themselves at the commencement of a gaming session and another player subsequently taking over the gaming session. The confirmation may be required at randomly selected intervals. For example, the gaming machine 10 may randomly select a time interval between the range of 10 minutes and 20 minutes. When the randomly selected time interval since the gaming session commenced or the last confirmation was achieved, then the gaming machine 10 may operate the fingerprint scanner to attempt to obtain a fingerprint read. This may be attempted without indicating to the player that it is occurring.

If a read is not able to be obtained, the yellow LEDs may start flashing to indicate that confirmation is required. A one or two minute period may be provided for the player to confirm his or her identity by placing a finger on the fingerprint scanner 114 to allow a scan to occur. If the player allows his or her finger to be scanned and is confirmed as being the same player, then game play will continue and the green LEDs illuminated on the play button 70.

If the player does not allow his or her finger to be scanned when the period for confirmation expires, then the gaming machine 10 may end the gaming session by cashing out the player. If the scan reveals a print that does not match the player's print as recorded in the database 213A, then the yellow LEDs may continue flashing to indicate that a correct fingerprint scan is still required until the confirmation period expires, when the gaming machine 10 terminates the game play session and cashes out the player.

The period for confirmation may be selected to provide time for the player to notice the yellow flashing and have two or three attempts at a fingerprint scan. This allows a second or third scan to occur following an inaccurate first scan. Immediately prior to cashing a player out, the gaming machine 10 may pause game play so that the player can not play to draw the player's attention to the need to provide a correct fingerprint scan.

In addition, or as an alternative, the gaming machine 10 may require a fingerprint read when cash is inserted into or transferred to the gaming machine 10 and require a fingerprint read at the termination of the gaming session when the player cashes out. Cashing out may be refused if the player attempting to cash out is not the same, as indicated by the fingerprint read, as the player who inserted the cash. The credit on the gaming machine 10 may instead be transferred from the gaming machine 10 to a central storage location, for example the gaming floor management server 208. The player who inserted the cash may then be permitted to recover this transferred credit by, for example, going to a cashier station or terminal and having their finger scanned or presenting another identifier of the player.

The gaming system 200 may monitor which players are playing which machines. In one embodiment, this may be achieved by allocating a player a player identifier and storing a list of player identifiers at the gaming floor management server 208. In this way, the player may insert a player card containing the identifier, which is communicated to the gaming floor management server 208. The player profile may be downloaded from the database 213A in response to receipt of this player identifier. The use of fingerprint data is then used as further confirmation of the identity of the player.

The confirmation of the player's identity may be achieved as described above by communicating the biometric data from the gaming machine to a database system, for example the configuration sever 213 and database 213 described herein. The database system then checks that the biometric data matches biometric information contained on file associated with the player identifier and communicates back to the gaming machine 10 further configuration information, which may either indicate that game play is to continue, or that the game controller 101 is to cease game play.

Alternatively, the confirmation of the player's identity may be achieved by the configuration server 213 downloading the biometric information to the gaming machine 10. The game controller 101, or an intelligent peripheral device to the game controller 101, may then compare the biometric data read using the fingerprint scanner 114 with the downloaded biometric information. The configuration information that determines whether game play is to continue or cease may then be stored locally to the game controller. More specifically, if there is a match, no change to the gaming machine may be made and if there is not a match the gaming controller 101 may implement a process that terminates game play and displays on a display or otherwise advises the player that there has not been match. The player may be given another chance to provide correct information, during which time the current state of the game may be saved, to be resumed if the second scan does not result in a match. Alternatively, game play may only be terminated only if the second read fails to result in a match or another fixed number of attempts fails to give a match. A message may also be sent to a game floor attendant, for example by sending a message to the gaming floor management server 208, which then forwards a message to a pager, personal digital assistant or other device of an attendant. The message may indicate at which gaming machine 10 a player has provided non-matching biometric data.

In another embodiment, the players may be identified solely by fingerprint data, in which case the fingerprint information of each player may be stored in the database 213A associated with a player identifier, which may for example be a unique hexadecimal string. This string may then be communicated to the gaming floor management server 208.

The monitoring of which players are playing at which gaming machines allows detection of when the same player, according to the identity information, is playing at two different gaming machines 10 that are not located adjacent to each other. This indicates that it is likely that two different players are using the same identity. The gaming floor management server 208 may instruct both gaming machines 10 to cash out, or prevent play of only the gaming machine 10 that commenced the latter gaming session. This provides a disincentive to players to allow others to borrow their finger to allow game play.

Cash Redemption Terminal

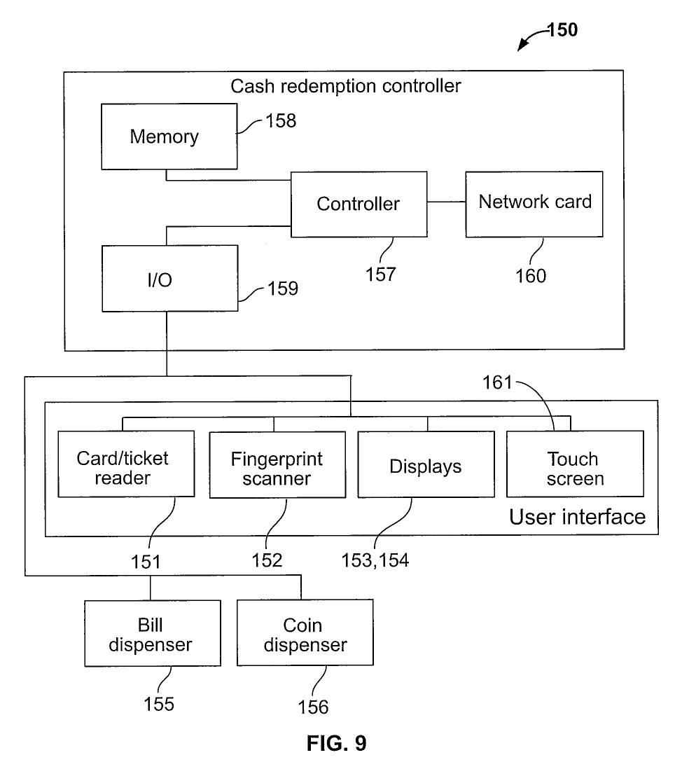

In addition to configuring gaming machines 10, the configuration information may be used to configure messages presented to a player at a cash redemption terminal. An example cash redemption terminal 150 is shown in FIG. 9. The cash redemption terminal 150 includes a card/ticket reader 151, a fingerprint scanner 152, first and second screens 153, 154, a bill dispenser 155 and a coin dispenser 156.

FIG. 10 shows a block diagram of the cash redemption terminal 150, further showing a cash redemption terminal controller 157 and associated memory 158 if provided separately from the controller 157. The controller 157 may be a microprocessor, programmable logic device or other suitable computational device. An input/output interface 159 is provided between the controller 157 and the peripheral devices of the cash redemption terminal 150 and a network card 160 allows communication with the network 201 of the gaming system 200. The cash redemption terminal 150 also includes a touch screen 161, which is provided over the screen 153.

The cash redemption terminal 150 receives messages from the gaming floor management server 208, which in this embodiment manages player accounts for the gaming system 200. The player identifies themselves at the cash redemption terminal 150, for example by inserting a player card into the card/ticket reader 151 and/or placing a finger on the fingerprint scanner 152. Instructions for the player to identify themselves and redemption information and data after the player has identified themselves is displayed on the first screen 153, which may be an LCD screen.

The second screen 154 may also be an LCD screen and messages may be played on the second screen 154. The messages may be customised for the player based on the player profile. For example, one message may state: “Thank you for playing at [venue name] and remember, when you play with real dollars, use real sense!”. This message may be used for players who have a player profile in the database 213A that has no or substantially no restrictions on game play.

For a player with a player profile that indicates that they are to receive reminder messages, the message may state: “Thank you for playing at [venue name]. You are receiving messages every 4 hours to remind you to play responsibly. Did you know you can set time and expenditure limits?”. The cash redemption terminal 150 may include an input device such as a touch screen and the LCD display may display a button indicated “set time and expenditure limits”. The player could then operate the cash redemption terminal to enter one or both of time and expenditure limits, which would be stored with their player profile and downloaded to a gaming machine 10 when the player identifies themselves at the gaming machine 10.

For a player that has a profile indicating that reminder messages are to be sent and a time limit imposed, the message may state: “Thank you for playing at [venue name]. You are receiving messaging every two hours to remind you to play responsibly. An automatic cash out will occur after three hours of play.” Other messages may be displayed that describe other configuration information as required. For example if a player has a time limit, but not a spend limit, the message may inform the player of the option to set a spend limit.

Different video clips may be played for players with different configuration profiles. As the players profiles include increasing restrictions on their gaming, the messages may include more direct or strenuous warnings. For example, the video clip may specifically pose the question “Are you spending too much?” if the player has configuration information specifying an automatic cash out after a period of time.

The cash redemption terminal 150 may allow the player to vary their profile, to either increase or decrease the messages that are sent to them, and their game play limits. The gaming system 200 may prevent any variation occurring from a gaming machine 10. Variation on the same day or within a certain period of time of a limit being imposed on a player may also be prevented. The gaming system 200 may also prevent variation occurring following the start of play of a gaming machine 10 at the gaming system 200, for example by leaving a gaming machine 10 and travelling to a cash redemption terminal 150 with the intention of returning to the same or a different gaming machine 10 with extended limits in place. Instead, this limitation of variation of the configuration information may be only imposed when the player is within a certain margin of the threshold, for example within 10% of the spend limit or within 15 minutes of the total time limit. The gaming system 200 may only allow changes to a player profile that impose less limits on gaming to come into effect 24 hours after they have been made. The gaming system 200 may also require that the player has cashed out of all gaming machines 10 for at least 18 hours or another selected percentage of that 24 hour period.

As can be seen from the example above, despite the ability to vary their profile to impose more or less limits on their gaming sessions, the messages may only ever invite the player to impose more limits or inform the player of the option to impose more limits on their gaming sessions.

In another embodiment, the gaming system 200 may operate as a ticket-in-ticket-out (TITO) system. In this embodiment, a player may provide real currency at a gaming machine or at a cashier's station or cashier terminal and is issued a ticket when he or she cashes out of the gaming machine or in return for providing real currency as the cashier's station or terminal. A ticket with credit on it may be able to be read by the gaming machines 10 to provide credit for a gaming session on that gaming machine 10. TITO systems are well known and therefore further details on the normal operation of such systems is not provided herein.

The player identifier of the player that cashed out of a gaming machine 10, or was present at the cashier's station or terminal, so causing it to print a ticket may be associated with the ticket. For example, the ticket may be assigned a unique number that is associated with the player identifier in the database 213A by the player tracking device 215. When funds are sought to be cashed out at a cashier's station, cash redemption terminal or applied to a credit meter of a gaming machine, then the player may be required to identify themselves. If the correct identifier is not received, cash out or application of the finds to the credit meter may be prevented. In addition, the ticket may be captured.

Additional security may be added by requiring the player to use biometric data to identify themselves. A fingerprint scanner may be used for this purpose. The result is that lost tickets can not be redeemed by any player other than the player who caused a cash out. This may also allow a player to recover their funds even if they never locate the ticket, because a central record, for example records maintained by the player tracking device 215 in the database 213 may be kept of all tickets associated with a player that have not been redeemed.

The use of the additional security provided by fingerprint scanning (or the capture of other biometric data) may be mandatory for play of the gaming system 200. Alternatively, it may be optional, so that players can ‘opt in’ or ‘opt out’ of having the additional security of requiring fingerprint authorisation prior to allowing redemption or spending of funds from a ticket.

Where in the foregoing description reference has been made to integers having known equivalents, then those equivalents are hereby incorporated herein as if individually set forth.

Those skilled in the relevant arts will appreciate that modifications and additions to the embodiments of the present invention may be made without departing from the scope of the present invention as defined in appended claims.

It will be understood that the invention disclosed and defined in this specification extends to all alternative combinations of two or more of the individual features mentioned or evident from the text or drawings. All of these different combinations constitute various alternative aspects of the invention.

1. A gaming system including a gaming machine and a configuration device in communication with the gaming machine over a communication channel, the configuration device maintaining in computer memory one or more player identifiers each associated with configuration information, the gaming machine including a player interface for receiving information defining a said player identifier, wherein the configuration device and the gaming machine communicate over the communication channel to provide the configuration information associated with a player identifier received by the player interface to the gaming machine and wherein the gaming machine configures itself dependent on the configuration information, the configuration information including a limit on a measurable aspect of gaming activity and wherein the gaming machine is further configured to provide an award if the limit is not exceeded.

2. The gaming system of claim 1, including a plurality of gaming machines, each in communication with the configuration device and configurable dependent on configuration information stored in the computer memory.

3. The gaming system of claim 2, wherein the communication channel includes a wide area network and the plurality of gaming machines include at least two gaming machines that are at remote physical locations from each other.

4. The gaming system of claim 1, wherein the measurable aspect includes at least one aspect selected from the group including: turnover, time played, rate of play and/or rate of expenditure, and wager size per game play.

5. The gaming system of claim 1, wherein if the limit is exceeded, the award is reduced or forfeited.

6. The gaming system of claim 1, wherein if the limit is exceeded, the award is reduced to a second award, and the gaming system awards the second award if a second limit, of greater magnitude than the first limit, is not exceeded.

7. The gaming system of claim 1, wherein the measurable aspect is enduring and the gaming system further includes a player tracking device that receives information defining the measurable aspect from a gaming session and stores it in electronic storage, wherein the gaming machine is operable to receive at the communication interface historical information on said measurable aspect, combine the historical information with current information on the monitored aspect and compare the resulting combined value with the limit for the purposes of determining whether the award is awarded.

8. The gaming system of claim 1, wherein the configuration information defines a plurality of limits and the gaming machine provides one of a plurality of different awards depending on which lowest limit is not exceeded.

9. The gaming system of claim 1, wherein when the limit is first exceeded, the gaming system provides a notification of this event and provides an option to cash out/quit now and still receive the award, or continue play without receiving the award.

10. A gaming machine including a player interface that includes a game play activator, wherein the game play activator includes a fingerprint scanner that scans a fingerprint of a player when that player operates the game play activator by placing his or her finger on the game play activator for a duration sufficient to obtain the scan.

11. The gaming machine of claim 10, wherein the game play activator includes a contoured surface that tends to locate a finger of player onto the fingerprint scanner.

12. The gaming machine of claim 10, wherein the game play activator includes at least one indicator, the indicator indicating to the player the status of the fingerprint scanner.

13. The gaming machine of claim 12, wherein the status of the fingerprint scanner includes a first status in which a fingerprint scan is required and is yet to be completed and a second status in which a fingerprint scan has been obtained.

14. A gaming system including a plurality of gaming machines that implement a ticket-in-ticket-out system for recording credit of a player, wherein the tickets include a player identifier that is associated in a database system with biometric information and wherein the gaming machines each include a biometric data reader and require the provision of biometric data before allowing redemption or spending of funds from a ticket, wherein said redemption or spending is refused if the biometric data does not match the biometric information associated with the player identifier.

15. The gaming system of claim 14, wherein the gaming system stores a record of unredeemed or spent funds on tickets.

16. A method for use with a gaming machine having a display and a user interface in communication with a computational controller to provide game play of a wagering game, the gaming machine including a communications interface for communicating with a computational device separate from the gaming machine, the method including:
receiving at the user interface an identifier of a player;
using the communications interface communicating the identifier onto a communications channel;
receiving configuration information at the computational controller, the configuration information including information identifying a limit for a measurable aspect of game play; and
monitoring the measurable aspect of game play on the gaming machine,
controlling the gaming machine to award an award if a player ends game play without exceeding the limit;
if the limit is exceeded, either reducing the award or forfeiting the award.

17. The method of claim 16, further including combining the monitored measurable aspect of game play on the gaming machine with a previously recorded value relating to previous game play in another gaming session and awarding the award only if the combined value is less than the limit.

18. The method of claim 16, wherein measurable aspect includes at least one aspect selected from the group including: turnover, time played, rate of play and/or rate of expenditure, and wager size per game play.

19. A method of operating a plurality of gaming machines in communication with a centralised or distributed database system containing biometric data for a plurality of players, the method including implementing a ticket-in-ticket-out system for recording credit of a player, printing on tickets of the ticket-in-ticket-out system a player identifier that is associated in a database system with biometric information, and before allowing redemption or spending of funds from a said ticket requiring the provision of biometric data and refusing said redemption or spending if the biometric data does not match the biometric information associated with the player identifier.
